(19) United States
(12) Patent Application Publication
(10) Pub. No.: US 2006/0206827 A1
(43) Pub. Date: Sep. 14, 2006

(54) Live graphical user interface builder

(75) Inventor: David R. DeWitt, Livermore, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/077,469

(22) Filed: Mar. 10, 2005

(51) Int. Cl. G06F 9/00

(52) U.S. Cl. 715/762; 715/763; 715/764; 715/967

(57) ABSTRACT

A graphical user interface (GUI) builder program is provided on a server. The GUI is built for interaction with a remote or local application, such as a client application being run on a remote processor. The GUI builder program allows connection with the GUI to the application while the GUI is live or being built. Without restarting either the application or the GUI, the GUI may be updated, altered or changed. During a same build session, the GUI and application interactions or operations are tested without shutting down or ending the build session.

### BACKGROUND

The present invention relates to a graphical user interface (GUI). In particular, a GUI for interaction with a client application is built.

GUIs and the application for which they are designed may be developed separately. For example, a plurality of tools is provided for designing GUIs. Different controls or components of the GUI are selected from a pallet of controls or components and placed within a GUI display. After a plurality of selections, placements and edits, the design of the graphic user interface is completed. After the design is complete, the GUI is complied into a code. A programmer attaches call-back code or otherwise configures the graphic user interface for interacting with the separately designed application. For example, specific packetizing and other communications hard coding is written for each interactive graphic user interface component. To test operation with the application, the application and the graphic user interface are restarted for operation together.

A GUI builder program operates separately from the application for which the graphic user interface is built. The builder program generates a file containing a graphic user interface build instructions, such as an XML file. The file is in a proprietary language, such as provided by coding callback functions. The build instructions may be specified in a language of the application for which the graphic user interface is to operate. Pre-processed or pre-compiled instructions in a standard or binary form may alternatively be provided. For each test of the graphic user interface or associated application functionality, at least one of either the application or the GUI programs is restarted.

### BRIEF SUMMARY

By way of introduction, the preferred embodiments described below include methods, systems and computer readable media with instructions for building a GUI. A builder program is provided on a server for building the GUI. The GUI is built for interaction with a remote or local application, such as a client application being run on a remote processor. The GUI builder program allows connection with the GUI to the application while the GUI is live or being built. Without restarting either the application or the GUI, the GUI may be updated, altered or changed while live. The GUI and application interactions or operations are tested without shutting down or ending the build session.

In a first aspect, a method is provided for building a GUI. A GUI including a first component is rendered to a server. The server is connected with an application. Interaction between the application and the component of the GUI is provided. The GUI is again rendered with the first component and an additional component after the provision of the interaction between the application and the first component. The additional rendering occurs during a same build session.

In a second aspect, a system is provided for building a GUI. A server has a GUI builder program. A display connects with the server. The display is operable to display the GUI in response to the builder program. A processor has an application. The application is operable to communicate with the builder program. The components of the GUI are operable with the application while the GUI is being built using the builder program.

In a third aspect, a computer readable storage media has data representing instructions executable by a programmed processor for designing a GUI. The storage media includes instructions for: providing selectable GUI components; rendering the GUI in response to selection of one or more of the selectable GUI components; providing communications to or from a separate application, the communications associated with the GUI components; and altering the selectable GUI components during a build section.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for building a GUI;

FIG. 2 is a flow chart diagram of one embodiment of a method for building a GUI;

FIG. 3 is a graphical representation showing a GUI being built while interacting with an associated application.

### DETAILED DESCRIPTION OF THE DRAWINGS AND PRESENTLY PREFERRED EMBODIMENTS

A GUI server provides a builder program for constructing live user interfaces. The server provides dynamic GUI layout management for the GUI. The builder program issues commands to the server that builds the GUI. The GUI is functioning as the GUI is being built. Client applications may interact with the GUI, receiving events and changing the states of controls and the layout parameters for layout management. Update and event callback software may be developed interactively with the GUI as the GUI is built and configured. Clients of the GUI server may operate the GUI in real time for development, prototyping and testing purposes.

The builder program allows selection of GUI components, such as clicking and dropping a desired GUI control. The GUI components may be sized, labeled or otherwise positioned and used for use within the GUI. Canned handlers or software code for handling the selected type of GUI components are assigned. The canned handler is assigned as the GUI is built, allowing interaction of the particular GUI component with a client application. The GUI may be evaluated as the GUI is built. Canned handlers allow operation of the GUI without requiring hard coding for interacting with the client application.

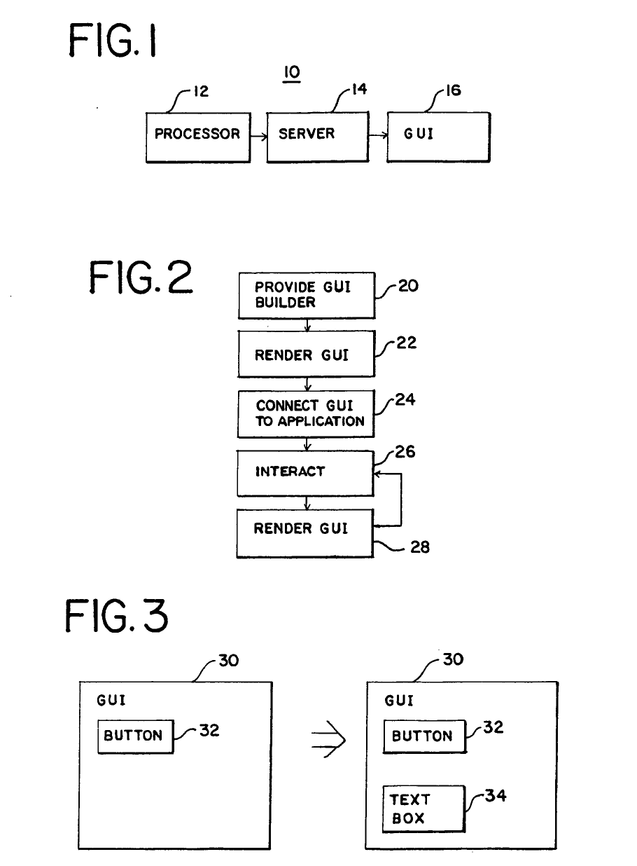

FIG. 1 shows a system 10 for building a GUI (GUI). The system 10 includes a client processor 12, a server 14 and a GUI 16. Additional, different or fewer components may be provided. For example, a plurality of different client processors 12 or client applications communicate with a single server 14, such as disclosed in U.S. Pat. No. ______ (application Ser. No. 11/009,502 (Attorney Reference No. 2004P18664US)), the disclosure of which is incorporated herein by reference. The different processors 12 run different client applications. A same GUI or distinct GUIs are generated by the server 14 for all or a sub-set of the client applications. More than one client application may interact with the GUI or server 14 while the GUI is being built, providing interactive optimization and testing of the GUI for more than one client application.

The client processor 12 and server 14 are a same or different computer, server, network, general processor, application specific integrated circuit, digital signal processor, multiple processors, field programmable gate array, analog circuit, digital circuit, combinations thereof or any other now known or later developed device for running an application. In one embodiment, the client processor 12 and/or server 14 are a controller or other processor operating on an embedded system, such as a medical imaging system. For example, a control processor of a medical diagnostic ultrasound imaging system is used.

The client processor 12 is operable to run a client application. The client application is for any use. For example, the client application is software for operating a medical imaging system, such as a medical diagnostic ultrasound imaging system. The software may be implemented on a computer for testing, or may be ported to an embedded imaging system. As another example, the client application is for use on a workstation for three dimensional image rendering. As yet another example, the client application runs on a server for processing orders received via the Internet or an intranet.

The client application is operable to communicate with a builder program run as an application on the server 14. The communication allows operation of the GUI with the client application while the GUI is being built using the builder program. The GUI is built for use with the client application during a build session and for use after being designed. A build session corresponds to designing the GUI without restarting, turning off or reloading the build program, the client application, or both. The GUI is functional during the build session before the design of the GUI is complete. The GUI is a live interface operable to be controlled by the builder program and the client application while being built. More than one client application may communicate with the builder program for operating or testing a common GUI during the build session. For example, each client application interacts with a same or common GUI component or different GUI components in a same or common GUI.

In one embodiment, the client application is also operable to generate GUI information, such as a specific request for GUI components. For example, the client application generates information assigning a value or selectable options associated with one or more GUI components. Alternatively, the server 14 generates the graphics user interface 16 without information from the client application.

The server 14 is a device for rendering a GUI and/or running a builder program. The builder program may be run on a different device or server than the server for rendering the GUI. In one embodiment, the server 14 is a processor operable to run an operating system, HTML browser, or other hardware or software for generating a display and interacting with a user input. The server 14 is operable to manage the graphics user interface 16. The server 14 is a same or different processor than used for the client processor 12. In one embodiment, the server 14 is embedded in a system, such as a medical imaging system. Alternatively, the server 14 is part of the Internet or an intranet computer network.

The server processor 14 is operable to run a server application. The server application is a program, software, code, firmware, hardware, combinations thereof or other components for providing data or serving the client application. In one embodiment, the server application generates a GUI, such as disclosed in U.S. Pat. No. ______ (application Ser. No. 11/009,502 (Attorney Reference No. 2004P18664US)). For example, the server application is operable to generate a GUI. The server application renders the GUI with one or more components or GUI controls. For example, the server application renders a first GUI component in a first state and is operable to render the GUI with the first GUI component in a second state in response to data from the client application during a same build session. A control layout description is provided by or to the server 14 for generating the GUI, such as the builder program providing the layout description.

The builder program includes a separate or common GUI for designing or building the GUI for the client application. The builder program includes a canvas, tools, images, video, selectable GUI components or controls (e.g., text box, slider controls, buttons, scroll box, drop down menus, video script, check boxes, combinations thereof and/or others), standard or canned coding for the selectable GUI components and/or other features. The builder program is operable to allow selection and placement of one or more components for the GUI by a user. Additional information for the component may be initially, later or never provided by the client application. The builder program is also operable to assign a standard or canned interaction code to the any appropriate selected GUI component. For example, a GUI component for interacting with the client application is selected. The builder program selects a default or appropriate operating code for communicating information about the state or activation of the GUI component to the client application. Alternatively, a list of possible standard interaction codes is provided to the user for selection, such as a search function code or a description function code for a text box GUI component. The user selects the desired operating code to provide information to or receive from the client application. Using the canvas, tools, selected components and/or selected coding, the builder program allows a user to design and build a functioning GUI.

The GUI 16 is a display, an HTML document, a collection of codes, a program, or other information for generating a GUI display for use by a user. The GUI 16 interacts with user input devices, such as a mouse, track ball, touch screen, capacitive sensing pad, keyboard, buttons, sliders, knobs, buttons, sensors or other user input devices. The display or display information is provided by the server application of the server 14 to a remote or local display for the GUI 16. The content of the GUI 16 is provided by the builder program using the server 14 during a building session. After the GUI is complete, the client application, the server 14 or other source provides the GUI 16 as designed with the same coding provided by the builder program. Alternatively, the coding for operation of the GUI or communication is altered by a programmer after completion by the builder program.

The instructions for implementing processes at the client processor 12, the processes of the client application, the processes of the server 14, and/or the processes of the builder program are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, filmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer or system.

FIG. 2 shows one embodiment of a method for building a GUI. The method is implemented using the system 10 of FIG. 1 or a different system. Additional, different or fewer acts than shown in FIG. 2 may be provided. For example, the repetition of Acts 26 and 28 is not provided. The acts may be performed in the same or a different order.

In Act 20, a GUI builder is provided. The builder allows for selectable GUI components. The selectable GUI components are provided in a list, template, through a menu structure or by importing. The GUI components are selected for use on a canvas or other layout structure. The GUI builder program on the server provides, arranges or uses the GUI components. The builder program is separate from an application for which the GUI is generated. The builder program renders the GUI based on the selection of different components, characteristics of the components and/or placement of the components. For example, the color, size, shape, contrast, connections, text, label, or other information associated with the component maybe edited, selected, or otherwise provided for use. The builder program is operable to perform renderings based on the GUI components, such as rendering the GUI 30 shown in FIG. 3 with the selectable GUI button 32.

In Act 22, the GUI 30 (FIG. 3) is rendered. Builder program renders the GUI with one or more components, such as the button component 32 shown in FIG. 3. The user selects a component, such as selecting a file, icon, name or other information and places the component at a desired location on the GUI canvas or template. The display of the canvas or template with the selected component is the rendering of the GUI for a client application. Alternatively, the GUI for the client application is rendered in a separate window, display or location that mirrors the canvas or GUI of the builder program without the builder program menus, lists or other builder program specific information.

In addition or as an alternative to selection by a user of components from the builder program, information is provided by a client application for commanding the generation of a specific or type of GUI component. Further information may alternatively or additionally indicate a characteristic of a GUI component, such as text to be placed adjacent to an image or within a selectable text box component of the GUI.

The GUI 30 with the selected component, such as the button 32, is generated during a building session. The GUI under design may be saved at different points throughout the build session. The GUI is designed without restarting the build program. During the build session, the selected GUI component or components are functional, such as operable to generate an indication of change of state in response to user input or operable to reflect information provided from a client application, such as inserting text within a text box. As the GUI is rendered, the selected GUI components are functional.

In Act 24, the server is connected with one or more client applications. The rendering and connection of Acts 22 and 24 are used to build the GUI for live operation. As the GUI is constructed, the connection provides for live operation of the GUI or partially designed GUI. The server and associated builder program is used to build and control a GUI and also connects using an inter-process communications mechanism, such as an IP/TCP or other now known or later developed communications format, with the client application. The builder program is provided with address or other information associated with the client application for exchanging information. Alternatively, the client program provides the builder program with the appropriate address information. The builder program provides a command set that allows client applications to communicate with the GUI at run time or while being built. Operations such as writing data or other information to the GUI, receiving notification of GUI events, and/or the retrieval of data from GUI items may be accomplished by submitting the appropriate commands from the client application to the server. For example, the client application is able to issue commands to the server for altering one or more components. Using a command set and software application programming interface of the GUI builder program, the live GUI can be controlled by the GUI builder program, the server and/or by the client application.

In Act 26, the connection of the GUI to the application or applications in Act 24 provides for interaction. Communications to and/or from the separate client application are provided for information associated with the GUI components. The client application may be notified of a new GUI component, of a detected GUI event, or when a new GUI is available. The builder program assigns identification to each GUI component, such as an identification indicating the type of GUI component or type of information associated with the GUI component. Alternatively, the client application provides names, labels or other indications referencing a particular GUI component during the design. Interaction allows the client application to submit commands to the server or builder program as the GUI is constructed. The GUI's content, layout, properties, event handling, data updates and/or information exchange with the client application is developed with information from the client application, the builder program, the rendered GUI or combinations thereof. The information is provided in real time such as the client application, the GUI server, and/or the builder program need not be restarted in order to develop and test the functionality of the GUI. Developing, prototyping, testing or combinations thereof of the GUI are provided while the GUI is being built, such as during the build session.

The builder program assigns handler code with appropriate GUI components. Alternatively, the client application communicates the handler code to the builder program. The handler code is then connected or assigned to the GUI component. The handler code is standardized, such as canned handler code for communicating information to or from selected GUI components. For example, canned handler code for providing text entered in a text box in response to a selected event is assigned to a new text box. In response to detection of the particular event, the handler code then packets the text in a standard format or a format indicated by the client application or builder program for transmission to the client application. The communications are provided as a function of the operation code during the build session. Rather than requiring later programming of code associated with specific components, a standardized, canned or otherwise provided handling code allows for interaction during the design process. The operation code and the associated GUI components are tested or used during the build session. For example, an event notification, change of state of the GUI component during testing, or other information are sent to the client application. As another example, a change of state, layout, layout parameter or other characteristic of the GUI component is instructed by the client application. The builder program then alters the GUI component accordingly while the GUI is designed. For example, GUI building commands are provided by the builder program for use by a client application. In response to receipt of a command from the client application, the builder program builds, configures, connects and/or modifies the GUI. The GUI is assembled in response to instructions from the client application by issuing commands to the server or builder program while running. Alternatively or additionally, the builder program attaches special handling codes to the GUI for preventing or allowing control or development from the client application.

In Act 28, the GUI is rendered in response to further design or building of the GUI. After interaction is provided between the client application and an original GUI component, the additional GUI component is added during the same build session, such as adding the text box 34 shown in FIG. 3. The GUI 30 is rendered as discussed above in Act 22. The additional rendering incorporates any alternations, changes, edits, additions or deletions in response to the interactions of Act 26. For example, a client application, user or builder program issues commands to the server for altering one or more of the GUI components. In addition or as an alternative to adding a GUI component, one or more of the GUI components may be removed. During the build session, the user selects a GUI component and deletes the component by pressing a delete button or dragging the GUI component off of the canvas. In response to removal of the GUI component, the builder program also removes any handling or operation code associated with the GUI component. The operation or handling code is removed automatically in response to removal of the GUI component.

By continuing to provide interaction between the client application and the GUI in Act 26 and associated rendering in Act 28, the GUI for the client application is designed or built. Each subsequent rendering occurs without having to restart the client application and/or without having to restart the GUI or builder program. Changes are merely rendered or applied to the GUI. Any of the builder program, GUI or client application may be restarted, such as associated with design occurring over a couple days time period.

Any process may be used for interacting between the client application and the GUI. For example, button 32 is created on the GUI. The buttons enabled state is configured by the builder program to depend on a value of data that may be loaded into the server by the client application. The handling code provides a variable name for receiving and applying the data to the button 32. The behavior of the button 32 is then tested interactively. The button 32 is configured by the builder program to send an even notification to the client application. In response to reception of the event notification, the client application changes the value for the button 32 to a value that enables the button, indicating a successful interaction or communication associated with the button. When the button is later clicked, a message is sent to the client application using the assigned handling code. The client application may, in response to the notification or at another time or trigger, set the value of the button 32 to a new value or state. The handling code associated with the button 32 as first selected and positioned within the GUI 30 provides for the interaction to further establish the connection between the GUI and the application. Alternatively or additionally, the handling code is less dependent on the client application. For example, the button 32 is assigned handling code with the button currently active. The communications between the GUI button 32 and the client application is then tested.

After the GUI is designed, the GUI is ready for operation. The operation code assigned to particular components is used during normal operation. For example, the GUI is provided with a client application on an embedded system. In response to activation of the client application, the GUI is rendered. The interactions between the GUI and client application is provided as established by the builder program. In the subsequent sessions, the GUI is rendered and used without further alteration.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for building a graphical user interface, the method comprising:
first rendering the graphical user interface including a first component with a server;
connecting the server with an application;
providing for interaction between the application and the first component; and
second rendering the graphical user interface including the first component and a second component after providing for interaction between the application and the first component during a same build session.

2. The method of claim 1 wherein first rendering and connecting comprise building the graphical user interface live.

3. The method of claim 1 wherein connecting comprises connecting the application with the graphical user interface with an interprocess communications mechanism.

4. The method of claim 1 wherein the first, second or both the first and second rendering of the graphical user interface comprises issuing commands to the server for altering the first or second components while the graphical user interface is functional with the application.

5. The method of claim 1 wherein providing for interaction comprises developing, prototyping, testing or combinations thereof of the graphical user interface in real time while being built.

6. The method of claim 1 wherein providing interaction comprises sending event notification to the application, changing a state of the first component by the application, changing a layout parameter of the first component by the application or combinations thereof.

7. The method of claim 1 wherein providing interaction comprises connecting canned handler code with the first component, the canned handler code operable to provide data to the application, receive instructions from the application or combinations thereof.

8. The method of claim 1 further comprising:
providing a graphical user interface builder program on the server, the builder program separate from the application, the builder program operable to perform the first and second rendering.

9. The method of claim 1 further comprising performing the first and second rendering without restarting the application and without restarting the graphical user interface.

10. The method of claim 1 wherein providing for interaction comprises assigning operation code to the first component;
further comprising:
testing the operation code of the first component; and
using the operation code with the first component during subsequent use of the graphical user interface in a subsequent session after building of the graphical user interface is complete.

11. A system for building a graphical user interface, the system comprising:
a server having a graphical user interface builder program;
a display connected with the server, the display operable to display the graphical user interface in response to the builder program; and
a processor having an application, the application operable to communicate with the builder program;
wherein components of the graphical user interface are operable with the application while the graphical user interface is being built using the builder program.

12. The system of claim 11 wherein the server is operable to render the graphical user interface with a first component in a first state and is operable to render the graphical user interface with the first component in a second state in response to data from the application during a same build session.

13. The system of claim 11 wherein the builder program is operable to allow selection and placement of a first component for the graphical user interface by a user and is operable to assign a standard interaction code to the first component, the standard interaction code operable to provide information to the application.

14. The system of claim 11 wherein the graphical user interface is for the application and is functional before a design of the graphical user interface is complete during a same build session.

15. The system of claim 11 wherein the graphical user interface comprises a live interface operable to be controlled by the builder program and the application while being built.

16. A computer readable storage medium having stored therein data representing instructions executable by a programmed processor for designing a graphical user interface, the storage medium comprising instructions for:
providing selectable graphical user interface components;
rendering a graphical user interface in response to selection of one or more of the selectable graphical user interface components;
providing communications to or from a separate application, the communications associated with the graphical user interface components; and
altering the selected selectable graphical user interface component during a build session.

17. The instructions of claim 16 further comprising assigning operation code for the selected selectable graphical user interface during the build session;
wherein providing the communications is a function of the operation code.

18. The instructions of claim 16 wherein rendering is performed in response to commands from the separate application.

19. The instructions of claim 16 wherein rendering comprises generating the graphical user interface with the selected selectable graphical user interface component functional during the build session and without restarting a build program.

20. The instructions of claim 16 further comprising:
removing the selected selectable graphical user interface component from the graphical user interface during the build session; and
removing operation code associated with the selected selectable graphical user interface component automatically in response to the removal of the selected selectable graphical user interface component.

21. The method of claim 1 wherein first rendering comprises rendering the graphical user interface with a third component, and wherein connecting the server with an application comprises connecting the server with the application and an additional application;
further comprising:
providing interaction between the additional application and the third component of the graphical user interface during the build session.
